(19) United States
(12) Patent Application Publication
(10) Pub. No.: US 2010/0027555 A1
(43) Pub. Date: Feb. 4, 2010

(54) METHOD FOR PROCESSING LINK STATE ADVERTISEMENT AND ROUTING DEVICE

(75) Inventor: Chao Fu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/577,833

(22) Filed: Oct. 13, 2009

Related U.S. Application Data
(63) Continuation of application No. PCT/CN2008/070738, filed on Apr. 17, 2008.

(30) Foreign Application Priority Data
Apr. 20, 2007 (CN) 200710098194.3

(51) Int. Cl. H04L 12/56

(52) U.S. Cl. 370/401; 370/389

(57) ABSTRACT

A method for processing a Link State Advertisement and a routing device are provided. The method includes: receiving a Link State Advertisement via an interface; obtaining an address of the interface, which is a first Link-local Interface Address, and an address contained in the Link State Advertisement, which is a second Link-local Interface Address; and performing deletion related processing for the Link State Advertisement if the first Link-local Interface address is identical to the second Link-local Interface Address.

This application is a continuation of International Patent Application No. PCT/CN2008/070738, filed on Apr. 17, 2008, which claims the priority to Chinese patent application No. 200710098194.3 filed Apr. 20, 2007, entitled “Method for Processing Link State Advertisement and Router”, which are incorporated herein by reference as if reproduced in their entirety.

### FIELD OF THE INVENTION

The present invention relates to the field of communication, and in particular to a method for processing a Link State Advertisement and a routing device.

### BACKGROUND OF THE INVENTION

In practical networks, routing information is generally collected and distributed through the Border Gateway Protocol/Interior Gateway Protocol (BGP/IGP). Specifically, the Open Shortest Path First (OSPF) protocol, which is composed of OSPFv2 based on the IPv4 network and OSPFv3 based on the IPv6 network, is the most popular one among currently available IGP protocols.

OSPF is a link state (LS) protocol, which collects topology information and routing information of the currently existing devices in a network and represents such information by way of Link State Advertisement (LSA). The LSA information is sent to each device in the whole network by synchronizing and distributing mechanisms of OSPF. All the information forms the Link State Database (LSDB) of OSPF. Finally, OSPF devices in the whole network have totally identical LSDBs. Using the Shortest Path First (SPF) algorithm, each device calculates routing by taking itself as a root. According to OSPF, when an invalid LSA is received, it is required to delete it to avoid occurrence of invalid routing.

In the prior art, a method for processing a Link State Advertisement is as follows.

In the OSPFv3 environment, when receiving an LSA, a router analyzes the generation parameter contained in the LSA to determine the ID of the router generating the LSA, compares the determined ID with the ID of the local router itself, determines the LSA as being generated by the local router itself if the determined ID is identical to the ID of the local router, and if the LSA is invalid, deletes the LSA.

However, when the ID of the router is changed, it can not be detected out accurately whether the received LSA is generated by the local router itself, which results in invalid routing, and a routing calculation error may occur.

In the prior art, another method for processing a Link State Advertisement is as follows.

In the OSPFv2 environment, when receiving a network-LSA, the router extracts the Link State ID parameter contained in the network-LSA, determines whether the parameter is the IP address of an interface of the router, and if so, determines the LSA as being generated by the router itself and deletes the LSA.

However, in OSPFv3, the Link State ID parameter in the network-LSA is no longer the IP address of the router, but is the interface ID of the router. The interface ID is not unique in a broadcast network, thus the object of deleting the self-generated LSA can not be achieved.

### SUMMARY OF THE INVENTION

The embodiments of the present invention provide a method for processing a Link State Advertisement and a routing device, which can avoid occurrence of invalid routing, thereby improving routing efficiency.

An embodiment of the present invention provides a method for processing a Link State Advertisement. The method includes: receiving a Link State Advertisement via an interface; obtaining an address of the interface, which is a first Link-local Interface Address, and an address contained in the Link State Advertisement, which is a second Link-local Interface Address; and performing deletion related processing for the Link State Advertisement if the first Link-local Interface Address is identical to the second Link-local Interface Address.

An embodiment of the present invention further provides a routing device, which includes: a receiving unit, configured to receive a Link State Advertisement via an interface; an obtaining unit, configured to obtain an address of the interface, which is a first Link-local Interface Address, and an address contained in the Link State Advertisement, which is a second Link-local Interface Address; and a deleting unit, configured to perform deletion related processing for the Link State Advertisement if the first Link-local Interface Address is identical to the second Link-local Interface Address.

### BRIEF DESCRIPTION OF THE DRAWINGS

FIG. 1 is a general flow chart illustrating a method for processing a Link State Advertisement according to an embodiment of the present invention;

FIG. 2 is a structural schematic diagram illustrating a Link-LSA according to an embodiment of the present invention;

FIG. 3 is a flow chart illustrating the method for processing the Link State Advertisement according to a first embodiment of the present invention;

FIG. 4 is a flow chart illustrating the method for processing the Link State Advertisement according to a second embodiment of the present invention; and

FIG. 5 is a schematic diagram illustrating a router according to an embodiment of the present invention.

### DETAILED DESCRIPTION OF THE EMBODIMENTS

The embodiments of the present invention provide a method for processing a Link State Advertisement and a router for improving routing efficiency, and can be applied to the OSPFv3 environment where the ID of the router is changed.

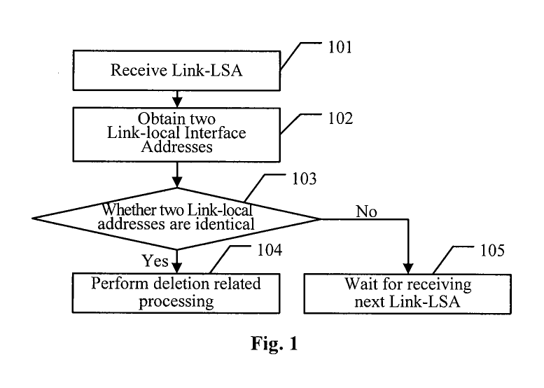

FIG. 1 is a general flow chart illustrating a method for processing a Link State Advertisement according to an embodiment of the present invention, which includes as follows.

101. Receive a Link-Link State Advertisement (Link-LSA).

A router (which is a kind of routing device) receives the Link-LSA via an interface, where the received Link-LSA contains a Link-local Interface Address identifying the interface address of the router generating the Link-LSA.

102. Obtain Link-local Interface Addresses.

The router needs to obtain two Link-local Interface Addresses, one of which is the Link-local Interface Address contained in the received Link-LSA, and another is the Link-local Interface Address of the interface receiving the Link-LSA. Because it is specified in the OSPFv3 that the Link-local Interface Address of the interface is stored by every OSPFv3 interface itself, the Link-local Interface Address of the interface can be obtained locally from the interface itself.

103. Determine whether the obtained two Link-local Interface Addresses are identical, execute the step 104 if so, and execute the step 105 otherwise.

104. Perform deletion related processing.

Because the Link-local Interface Address in the Link-LSA is identical to the Link-local Interface Address of the interface receiving the Link-LSA, the Link-LSA is determined as being generated by the router itself. Firstly announce to other routing devices that the LSA is invalid, and then delete the Link-LSA.

105. Wait for receiving the next Link-LSA.

If the Link-local Interface Address in the Link-LSA differs from the Link-local Interface Address of the interface receiving the Link-LSA, it is determined that the Link-LSA is not generated by the router itself, no processing is performed, and the router starts to wait for receiving the next Link-LSA to perform determination.

The structure of the Link-LSA is briefly discussed herein below.

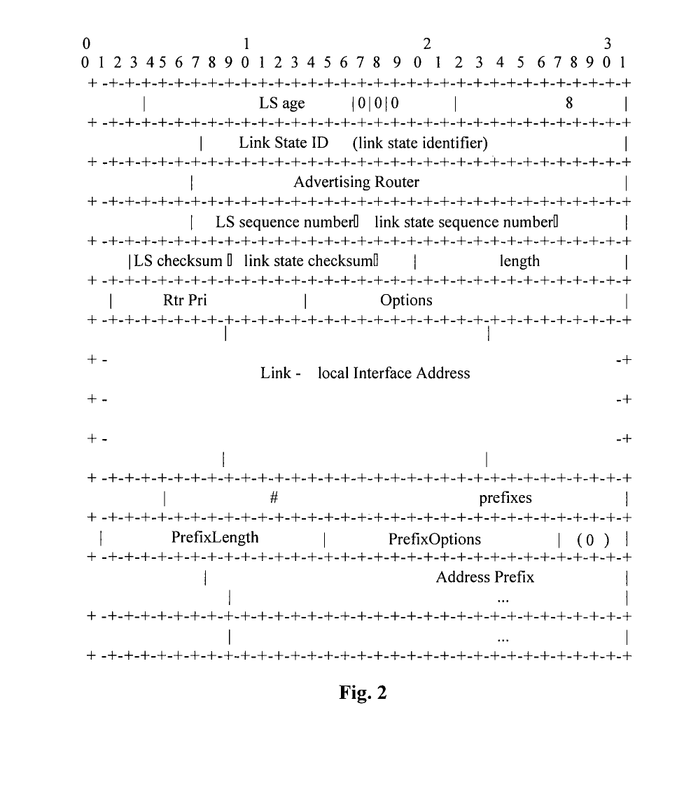

Reference may be made to FIG. 2. In the OSPFv3, a router generates a Link-LSA for every link connected with it.

Specifically, the “Advertising Router” parameter identifies the ID of the router generating the Link-LSA.

In addition, each Link-LSA contains the Link-local Interface Address of the interface. In the IPv6, the Link-local Interface Address of each interface of a physical network (a broadcast network, a point-to-point network, etc.) needs to be different from each other, otherwise collision may occur. Therefore, the Link-local Interface Address uniquely corresponds to the interface, and thus can be used to determine whether the Link-LSA is an LSA generated by the router itself.

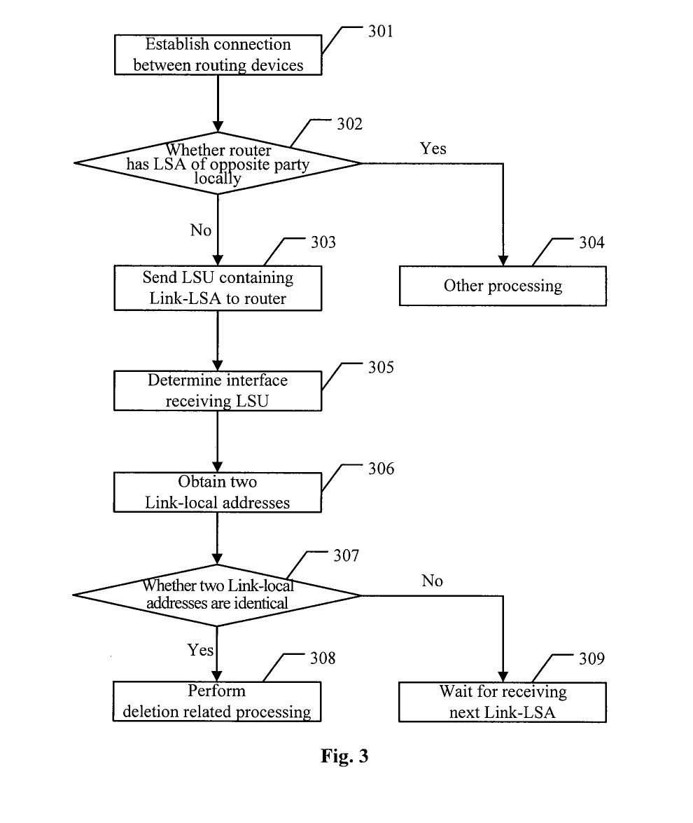

The method for processing the Link State Advertisement according to the embodiment of the present invention is described in detail herein below. FIG. 3 is a flow chart illustrating the method for processing the Link State Advertisement according to a first embodiment of the present invention, which includes as follows:

301. Establish a connection between routing devices.

When the router needs to communicate with another routing device (a second routing device), firstly the connection may be established. This can also be regarded as a process for exchanging the LSA, i.e. the router exchanges the LSA with the second routing device.

302. Determine whether the router has the LSA of the opposite party locally, execute the step 304 if so, and execute the step 303 otherwise.

The router determines whether the router itself has all the LSAs stored in the second routing device with whom the connection is required to be established.

303. Send a Link State Update (LSU) message containing the Link-LSA to the router.

If not having all the LSAs of the second routing device, the router sends an obtaining request to the second routing device, and the second routing device sends the LSU message containing the LSA of the second routing device itself and the Link-LSA to the router.

304. Perform other processing.

If the router has all the LSAs of the second routing device, perform other processing, e.g. wait for the next chance to obtain the Link-LSA.

305. Determine the interface receiving the LSU.

When receiving the LSU sent from the second routing device, the router determines the interface via which the LSU is received according to an identifier in the LSU. The specific process for determining the interface is contained in the prior art and is not described in detail herein.

306. Obtain Link-local Interface Addresses.

The router needs to obtain two Link-local Interface Addresses, one of which is the Link-local Interface Address contained in the received Link-LSA, and another is the Link-local Interface Address of the interface receiving the Link-LSA. Because it is specified in the OSPFv3 that the Link-local Interface Address of the interface is stored by every OSPFv3 interface itself, the Link-local Interface Address of the interface can be obtained locally from the interface itself.

307. Determine whether the obtained two Link-local Interface Addresses are identical, execute the step 308 if so, and execute the step 309 otherwise.

308. Perform deletion related processing.

Because the Link-local Interface Address in the Link-LSA is identical to the Link-local Interface Address of the interface receiving the Link-LSA, the Link-LSA is determined as being generated by the router itself. Firstly announce to other routing devices that the LSA is invalid, and then delete the Link-LSA.

Further deletion related processing can be performed, which in the embodiment includes recording the ID (i.e. the “Advertising Router” parameter) of the router generating the Link-LSA, searching for other LSAs having the same “Advertising Router” parameter, and firstly announcing to other routing devices that the searched-out LSA is invalid, and then deleting the LSA.

309. Wait for receiving the next Link-LSA.

If the Link-local Interface Address in the Link-LSA differs from the Link-local Interface Address of the interface receiving the Link-LSA, it is determined that the Link-LSA is not generated by the router itself, no processing is performed, and the router starts to wait for receiving the next Link-LSA to perform determination.

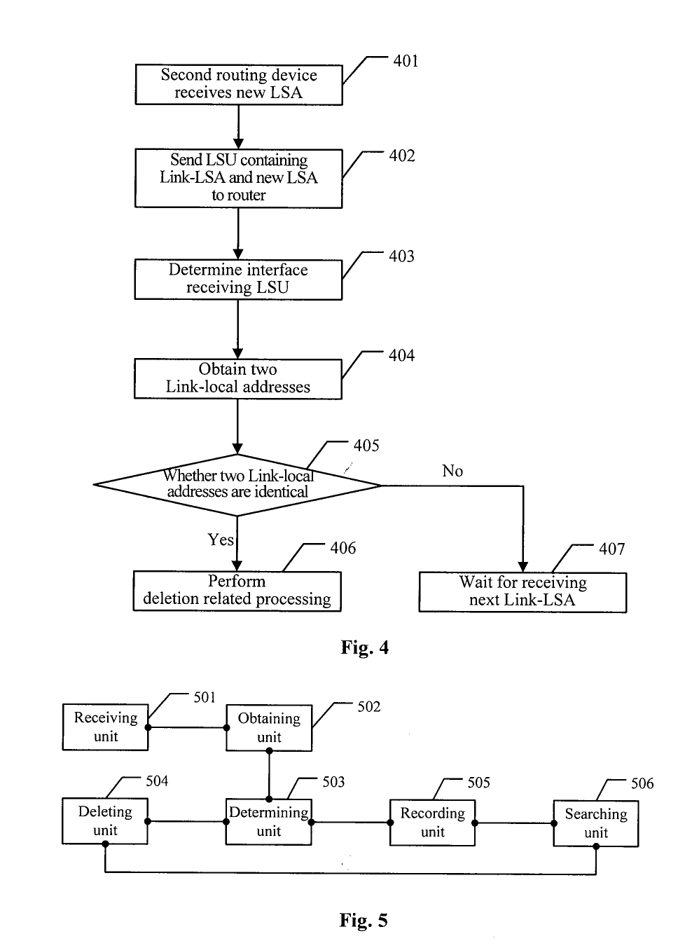

In this embodiment, the Link-LEA is carried and sent to the router through the LSU, with the LSU being sent when the connection is established between the router and the second routing device at which time the LSA is exchanged. It can be understood that the LSU may also be sent at other time. Another sending method is described hereinbelow. FIG. 4 is a flow chart illustrating the method for processing the Link State Advertisement according to a second embodiment of the present invention, which includes as follows.

401. The second routing device receives a new LSA.

402. Send the LSU containing the Link-LSA and the new LSA to the router.

When receiving the new LSA, the second routing device needs to flood the LSA to other routing devices to update the LSDBs at all locations, and the flooding process namely refers to the process sending the LSU containing the new LSA.

403. Determine the interface receiving the LSU.

When receiving the LSU sent from the second routing device, the router determines the interface via which the LSU is received according to an identifier in the LSU. The specific process for determining the interface is contained in the prior art and is not described in detail herein.

404. Obtain Link-local Interface Addresses.

The router needs to obtain two Link-local Interface Addresses, one of which is the Link-local Interface Address contained in the received Link-LSA, and another is the Link-local Interface Address of the interface receiving the Link-LSA. Because it is specified in the OSPFv3 that the Link-local Interface Address of the interface is stored by every OSPFv3 interface itself, the Link-local Interface Address of the interface can be obtained locally from the interface itself.

405. Determine whether the obtained two Link-local Interface Addresses are identical, execute the step 406 if so, and execute the step 407 otherwise.

406. Perform deletion related processing.

Because the Link-local Interface Address in the Link-LSA is identical to the Link-local Interface Address of the interface receiving the Link-LSA, the Link-LSA is determined as being generated by the router itself. Firstly announce to other routing devices that the LSA is invalid, and then delete the Link-LSA.

Further deletion related processing can be performed, which in the embodiment includes recording the ID (i.e. the “Advertising Router” parameter) of the router generating the Link-LSA, searching for other LSAs having the same “Advertising Router” parameter, and firstly announcing to other routing devices that the searched-out LSA is invalid, and then deleting the LSA.

407. Wait for receiving the next Link-LSA.

If the Link-local Interface Address in the Link-LSA differs from the Link-local Interface Address of the interface receiving the Link-LSA, it is determined that the Link-LSA is not generated by the router itself, no processing is performed, and the router starts to wait for receiving the next Link-LSA to perform determination.

In the OSPFv3, a router may generate a Link-LSA for every link connected with it no matter what kind of link it is, thus the processing method of the above embodiments can be applied to all types of networks, which is also independent of the state of each interface. Hence, the implementation range of the embodiments of the present invention can be extended.

The router according to an embodiment of the present invention is described hereinbelow. FIG. 5 is a schematic diagram illustrating a router according to an embodiment of the present invention, which includes as follows.

A receiving unit 501, an obtaining unit 502, a determining unit 503 and a deleting unit 504.

The receiving unit 501 is configured to receive a Link-LSA via an interface.

The obtaining unit 502 is configured to obtain a first Link-local Interface Address of the interface and a second Link-local Interface Address contained in the Link-LSA.

The determining unit 503 is configured to determine whether the first Link-local Interface Address is identical to the second Link-local Interface Address, and to send a deletion notification to the deleting unit if so.

The deleting unit 504 is configured to perform deletion related processing for the Link-LSA according to the deletion notification received.

A recording unit 505 is configured to record a first advertising router identifier of the Link-Link State Advertisement for which the deletion related processing is performed, and to send the first advertising router identifier a searching unit 506.

The searching unit 506 is configured to search for, in a domain, the Link State Advertisement the advertising router identifier of which is identical to the first advertising router identifier, to send the searched-out Link State Advertisement to the deleting unit 504, and to request the deleting unit 504 to perform deletion related processing for the Link State Advertisement.

It can be found from the above embodiments that, because the embodiments of the present invention perform determination for the Link-local Interface Address in the Link-Link State Advertisement (Link-LSA) and the Link-local Interface Address of the receiving interface, as well as because the Link-local Interface Address uniquely corresponds to the physical interface in a physical network implementing the OSPFv3 protocol, the LSA generated previously by the router itself can be detected out and deleted after the ID of the router is changed, thus avoiding occurrence of invalid routing and further improving routing efficiency.

The method for processing the Link State Advertisement and the router according to the embodiments of the present invention are described in detail. According to the idea described above, modifications may be made to the specific embodiments and the implementation range of the present invention. To sum up, the disclosure of the specification is not intended to limit the present invention.

What is claimed is:

1. A method for processing a Link State Advertisement, comprising:
receiving a Link State Advertisement via an interface;
obtaining an address of the interface, which is a first Link-local Interface Address, and an address contained in the Link State Advertisement, which is a second Link-local Interface Address; and
performing deletion related processing for the Link State Advertisement if the first Link-local Interface Address is identical to the second Link-local Interface Address.

2. The method according to claim 1, wherein the receiving the Link State Advertisement via an interface comprises:
receiving, via the interface by a first routing device, from a second routing device a Link State Update message containing the Link State Advertisement.

3. The method according to claim 2, wherein the receiving, via the interface by a first routing device, from a second routing device a Link State Update message containing the Link State Advertisement comprises:
establishing a connection between the first routing device and the second routing device;
determining, by the first routing device, whether the Link State Advertisement of the second routing device is stored in the first routing device, and sending a Link State Advertisement update request to the second routing device if not; and
receiving, via the interface by the first routing device, the Link State Update message containing the Link State Advertisement sent from the second routing device.

4. The method according to claim 2, wherein the receiving, via the interface by a first routing device, from a second routing device a Link State Update message containing the Link State Advertisement comprises:
receiving, by the second routing device, a new Link State Advertisement;
sending, by the second routing device on its own initiative, the Link State Update message containing the Link State Advertisement to the first routing device; and
receiving, by the first routing device, the Link State Update message via the interface.

5. The method according to claim 2, wherein the obtaining the first Link-local Interface Address of the interface comprises:
determining, according to a reception identifier in the Link State Update message, the interface receiving the Link State Update message; and
obtaining the first Link-local Interface Address of the interface from locally stored information of the determined interface.

6. The method according to claim 1, wherein an advertising routing device identifier of the Link State Advertisement is a first identifier, and the method further comprises:
searching for, in a domain, the Link State Advertisement the advertising routing device identifier of which is the first identifier; and
announcing that the searched-out Link State Advertisement is invalid and deleting the Link State Advertisement.

7. The method according to claim 1, further comprising:
waiting for receiving the next Link State Advertisement if the first Link-local Interface Address differs from the second Link-local Interface Address.

8. The method according to claim 1, wherein the Link State Advertisement is a Link-Link State Advertisement, Link-LSA.

9. A routing device, comprising:
a receiving unit, configured to receive a Link State Advertisement via an interface;
an obtaining unit, configured to obtain an address of the interface, which is a first Link-local Interface Address, and an address contained in the Link State Advertisement, which is a second Link-local Interface Address; and
a deleting unit, configured to perform deletion related processing for the Link State Advertisement if the first Link-local Interface Address is identical to the second Link-local Interface Address.

10. The routing device according to claim 9, further comprising:
a determining unit, configured to determine whether the first Link-local Interface Address is identical to the second Link-local Interface Address, and to notify the deleting unit to perform deletion related processing for the Link State Advertisement if so.

11. The routing device according to claim 9, wherein an advertising routing device identifier of the Link State Advertisement is a first identifier, and the routing device further comprises:
a recording unit, configured to record the advertising routing device identifier, which identifier is the first identifier, of the Link State Advertisement for which the deletion related processing is performed, and to send the first identifier to a searching unit; and
the searching unit, configured to search for, in a domain, the Link State Advertisement the advertising routing device identifier of which is the first identifier, to send the searched-out Link State Advertisement to the deleting unit, and to request the deleting unit to perform deletion related processing for the Link State Advertisement.

12. The routing device according to claim 9, wherein the Link State Advertisement is a Link-Link State Advertisement, Link-LSA.
